(19) United States
(12) Patent Application Publication
(10) Pub. No.: US 2023/0301294 A1
(43) Pub. Date: Sep. 28, 2023

(54) COLLOIDAL SOLUTION FOR EX-VIVO LUNG PERFUSION AND STORAGE

(71) Applicant: S.A.L.F. S.p.A. Laboratorio Farmacologico, Cenate Sotto (BG) (IT)

(72) Inventor: Carmelo GAGLIANO, Cenate Sotto (BG) (IT)

(21) Appl. No.: 18/022,159

(22) PCT Filed: Nov. 10, 2021
(86) PCT No.: PCT/IB2021/060388

§ 371 Date: Feb. 19, 2023

(30) Foreign Application Priority Data
Nov. 12, 2020 (IT) 102020000027050

(51) Int. Cl. A01N 1/02

(52) U.S. Cl. CPC A01N 1/021; A01N 1/0247

(57) ABSTRACT

The present invention relates to a colloidal solution free of human or animal blood derivatives for the ex-vivo perfusion, regeneration and storage of the lungs before transplantation.

The present invention relates to a colloidal solution free of human or animal blood derivatives for the ex-vivo perfusion, regeneration and storage of the lungs before transplantation.

The lungs are very delicate organs, easily susceptible to infections following the forced ventilation to which a patient is subjected when in intensive care, and very difficult to keep intact during explanation and subsequent transportation for donation.

In general it is possible to reuse only 15-30% of the organs that are made available by donors for transplantation. A very low percentage, especially considering that there are often no alternative therapies to transplantation for treating some lung diseases, such as terminal respiratory failure.

The Ex-vivo-Lung-Perfusion (EVLP) technique involves isolating the organ to be transplanted from the donor's body, and through an extracorporeal circuit, the lung is perfused with a storage solution that preserves cellular integrity and maintains the stability of the organ under conditions of constant humidity and temperature for the period necessary for effecting the transplantation procedures, the verification of suitability, and any possible transportation.

This method not only allows the lungs to be kept alive for as long as possible, but also regenerates edematous lungs or lungs affected by bacterial infections.

The storage solution used in the perfusion of the lungs prolongs the stability of the organ through mechanical and chemical-physical mechanisms which are summarized hereunder:
through osmotic characteristics of the solution;
through the electrolytic composition of the solution;
through mechanical protection of the endothelium of the vessels.

In the clinical context, during solid organ transplantation, due to the interruption of the vascular support, autolytic phenomena are inevitably triggered, linked to the separation from its own physiological context which guarantees functionality and homeostasis.

As a whole, these phenomena can be attributed to a rapid decline in the ATP reserves within the cell and to the reduced availability of energy sources.

This inevitably involves the redistribution within the cellular systems of metabolic substrates, an enormous variation in the electrolyte composition, a massive reduction in the pH and the activation, more generally, of some cellular processes such as proteolysis, lipolysis and lipid peroxidation. The excess of reactive oxygen species (ROS), in this phase, must therefore be considered as the natural consequence of this cascade of events. The nature of these processes is finely regulated at the molecular level, through the activation of well-defined pathways on which cellular systems leverage to ensure survival under unfavourable environmental conditions.

There are currently essentially two storage methods in the isolated lung: a first technique involves the interruption of ischemic damage through controlled hypothermia (static cold storage), a second is effected through pulsatile perfusion in hypothermia by means of a specific instrumentation (hypothermic machine perfusion). Both of these methods involve the use of organ conditioning solutions and the re-implementation of an adequate cell volume.

Organ conditioning solutions currently available on the market contain human albumin as oncotic agent, such as STEEN solution™.

The presence of albumin, however, gives the solution a series of weaknesses. Human albumin is in fact prepared from whole blood, plasma and serum of healthy human donors that may contain HbsAg, HCV, HIV, antibodies as contaminants with an impact on the health of the subject in which the lung is implanted (antibody antigenic reaction). Furthermore, when using human albumin there is a significant risk of the transmission of viral, bacterial or prion infections present as contaminants.

The authors of the present invention have now developed an aqueous colloidal solution free of human albumin suitable for the perfusion and regeneration of lungs isolated before implantation, which, containing an organic molecule for regulating the oncotic pressure, does not show the disadvantages or risks of the solutions currently used for the storage of organs.

The present invention therefore relates to a sterile aqueous colloidal solution comprising hydroxyethyl starch as oncotic agent at a concentration ranging from 45 to 55 g/L, dextran from 4 to 6 g/L, together with one or more osmotic agents, a buffer system and electrolytes for use in the medical field for ex-vivo perfusion and storage of isolated lungs to be transplanted.

The hydroxylated starch (HES PM 130; MS 0.42) present in the aqueous solution (water for injectable preparations) as oncotic agent is a modified starch, a branched-chain polysaccharide which increases the viscosity of the solution and the oncotic pressure. The presence of the hydroxylated starch oncotic agent in the solution according to the invention has the function of maintaining the oncotic pressure at the level of the capillaries and pulmonary alveoli and counteracting the possible formation of edema due to interruption of the passage of blood.

In a preferred embodiment of the invention the hydroxyethyl starch is present at a concentration equal to 50 g/L.

The dextran present in the aqueous solution is a glucose polymer which forms highly branched molecules and increases the viscosity of the solution forming colloids. It has the function of protecting the endothelium of the small capillaries of the pulmonary alveolus from the formation of clots. In a preferred embodiment of the invention, dextran is present in the solution at a concentration equal to 5 g/L.

The osmotic agent present in the solution is preferably selected from the group consisting of sodium chloride, calcium chloride dihydrate and glucose monohydrate or a combination thereof. According to a preferred embodiment, the sterile aqueous colloidal solution according to the invention has an osmolarity ranging from 280 to 350 mOsm/kg and a density ranging from 1.00 to 1.05 g/cm³.

In a particularly preferred embodiment, the buffer system comprises sodium bicarbonate as pH regulator and sodium phosphate monobasic dihydrate as regulator of the buffer system. The pH of the solution is preferably kept at around neutrality between 7.0-7.5.

The solution is sterile and non-pyrogenic, i.e. free of endotoxins, viruses, prions, bacteria, antibodies, antigens and derivatives from human or animal blood (i.e. albumin).

The electrolytic composition of the solution ensures maintenance of the chemical-physical balance of the cells. The electrolytic equilibrium is preferably maintained by the addition to the solution of one or more monohydrate or polyhydrate chlorinated salts, such as for example potassium chloride and magnesium chloride hexahydrate. Even more preferably, the above-mentioned chlorinated salts are present in the solution at a concentration within the ranges described in the following Table 1.

TABLE 1

| COMPONENT | g/l | Range | | CAS Nr. |
|---|---|---|---|---|
| Sodium chloride | 8 | 7.2-8.8 | g/l | 7647-14-5 |
| Potassium chloride | 0.34 | 0.30-0.38 | g/l | 7447-40-7 |
| Calcium chloride | 0.22 | 0.2-0.3 | g/l | 10035-04-08 |
| Dihydrate | | | | |
| Magnesium chloride | 0.24 | 0.2-0.3 | g/l | 7791-18-6 |
| Hexahydrate | | | | |
| Total chlorides | | 130-160 | mmoles/l | |

In a preferred embodiment of the invention, the composition of the colloidal aqueous storage solution is indicated in the following Table 2:

TABLE 2

| COMPONENT | g | mMoles | FUNCTION | CAS Nr. |
|---|---|---|---|---|
| Hydroxyethyl | 50 | / | Oncotic agent | 9005-27-0 |
| starch | | | | |
| (HES) 130/0.42 | | | | |
| Dextran 40 | 5 | / | Colloidal agent | 9004-54-0 |
| | | | Increases the viscosity of | |
| | | | the solution. | |
| Sodium chloride | 8 | 136.8 | Osmotic agent. | 7647-14-5 |
| | | | Makes the solution | |
| | | | isotonic. | |
| Glucose | 2.18 | 11 | Osmotic agent | 5996-10-1 |
| monohydrate | | | | |
| Potassium | 0.34 | 4.6 | Osmotic agent | 7447-40-7 |
| chloride | | | Maintains the cellular | |
| | | | electrolytic equilibrium | |
| Calcium chloride | 0.22 | 1.5 | Osmotic agent | 10035-04-08 |
| dihydrate | | | Increases the osmolarity | |
| | | | of the solution | |
| Magnesium | 0.24 | 1.2 | Osmotic agent | 7791-18-6 |
| chloride | | | Maintains the cellular | |
| hexahydrate | | | electrolytic equilibrium. | |
| Sodium | 1.26 | 15 | pH regulator | 144-55-8 |
| bicarbonate | | | | |
| sodium | 0.19 | 1.2 | Buffer system regulator | 13472-35-0 |
| phosphate | | | | |
| monobasic | | | | |
| dihydrate | | | | |
| Water for | enough to | | Solvent | |
| injectable | 1,000 mL | | | |
| preparations | | | | |

The ions are present in the solution in such quantity as to guarantee the extra-cellular electrolytic composition.

The sterile aqueous colloidal solution according to the invention can further comprise a chelating agent for maintaining the stability of the sodium bicarbonate, such as, for example, the sodium salt EDTA.

The present invention also relates to the use of the sterile aqueous colloidal solution detailed above for the ex-vivo perfusion and storage of isolated lungs to be transplanted.

By applying the aqueous colloidal storage solution according to the invention to the ex-vivo pulmonary perfusion technique (EVLP), the suitability for organ transplantation has in fact been improved.

The sterile aqueous colloidal solution according to the invention is preferably packaged in PVC-free medical plastic containers (such as for example medical bags) with double sterile wrapping.

Finally, the invention contemplates a process for the preparation of the aqueous colloidal storage solution described above, comprising the following steps:
a) dissolution of the components of the aqueous colloidal storage solution described above in a volume of water for injectable preparations equal to approximately 80% of the final volume;
b) addition of sodium metabisulfite and EDTA sodium salt;
c) pH adjustment around neutrality by the addition of NaOH (1N) or HCl (1N);
d) bringing to volume by the addition of water for injectable preparations;
e) filtration at 0.2 microns;
f) filling of the bags under a laminar flow;
g) sterilization of the bags in an autoclave at 115° C.-118° C.

The addition of sodium metabisulfite in step b) is preferably effected at a concentration ranging from 0.2 to 0.4 g/L, preferably 0.3 g/L.

According to a preferred embodiment, the sodium metabisulfite is added in combination with medical nitrogen.

The addition of sodium metabisulfite in the dissolution phase allows the oxidation processes of the organic molecules present in the solution to be reduced. The above-mentioned component, during the subsequent sterilization phase, releases sulfur dioxide which acts as an adjuvant for the reduction of the hot oxidation processes of the organic molecules present in the mixture: mixture:

The chemical reaction that is generated is the following:

2H⁺+Na₂S₂O₅→2Na+2SO₂+H₂O

This is a technological expedient for preserving the chemical-physical characteristics of the molecules in solution during the sterilization phase.

The sterilization takes place by filtration at 0.2 microns and subsequent autoclave sterilization of the bags containing the solution at a T° C. 115-118° C. F0>8. Sterilization eliminates all forms of life present in the solution and on the surface of the bag making the device sterile in its entirety. The sterility of the surface allows the product to be used in the operating theatre, minimizing the risk of microbial and viral contamination of the patient and the surrounding environment.

The whole production process from the preparation phase to the filling phase of the non-sterile bag must be effected under vacuum conditions and in the presence of nitrogen (oxygen content in the bulk<1 ppm).

Finally, a 100% visual inspection of the bags forming the lot is effected and packaging in labelled cardboard boxes.

1. A sterile aqueous colloidal solution comprising:
hydroxyethyl starch at a concentration within the range of 45-55 g/L;
dextran at a concentration within the range of 4-6 g/L;
sodium metabisulfite and EDTA sodium salt; and
one or more osmotic agents, a buffer system and electrolytes, for use in the medical field for ex-vivo perfusion and storage of isolated lungs to be transplanted.

2. The sterile aqueous colloidal solution according to claim 1, wherein hydroxyethyl starch is present at a concentration of 50 g/L.

3. The sterile aqueous colloidal solution according to claim 1, wherein dextran is present at a concentration of 5 g/L.

4. The sterile aqueous colloidal solution according to claim 1, wherein said one or more osmotic agents are selected from the group consisting of sodium chloride, calcium chloride dihydrate, glucose monohydrate and combinations thereof.

5. The sterile aqueous colloidal solution according to claim 1, wherein said buffer system comprises sodium bicarbonate and sodium phosphate monobasic dehydrate to keep the pH between 7.0-7.5.

6. The sterile aqueous colloidal solution according to claim 1, wherein said electrolytes derive from one or more chlorinated salts, selected from the group consisting of potassium chloride, magnesium chloride hexahydrate or anhydrous, calcium chloride dihydrate or anhydrous, and sodium chloride.

7. The sterile aqueous colloidal solution according to claim 6, wherein the concentration of said chlorinated salts is within the range of 130.00-160.00 mmoles/l of total chloride.

8. A method of ex-vivo perfusion, regeneration and storage of lungs to be transplanted comprising perfusing the lungs to be transplanted with the sterile aqueous colloidal solution according to claim 1.

9. A process for the preparation of the sterile aqueous colloidal solution according to claim 1, comprising the following steps:
a) dissolving of the hydroxyethyl starch, dextran and one or more osmotic agents, a buffer system and electrolytes components of the solution in a volume of water for injectable preparations equal to about 80% of the final volume;
b) adding the sodium metabisulfite and EDTA sodium salt;
c) adjusting the pH to about neutrality by adding NaOH or HCl;
d) bringing to volume by adding water for injectable preparations;
e) filtering at 0.2 microns;
f) filling bags with the filtered solution from step e) under a laminar flow;
g) sterilizing the bags in an autoclave at 115° C.-118° C.

10. The process according to claim 9, wherein the sodium metabisulfite is added in step b) at a concentration within the range of 0.2 g/L-0.4 g/L.

11. The process according to claim 9, wherein the sodium metabisulfite is added in step b) at a concentration of about 0.3 g/L.
